(19) United States
(12) Patent Application Publication
(10) Pub. No.: US 2015/0324408 A1
(43) Pub. Date: Nov. 12, 2015

(54) HYBRID STORAGE METHOD AND APPARATUS

(71) Applicant: Altibase Corp., Seoul (KR)

(72) Inventor: Seung Won Lee, Seoul (KR)

(21) Appl. No.: 14/637,584

(22) Filed: Mar. 4, 2015

(30) Foreign Application Priority Data
May 8, 2014 (KR) 10-2014-0054932

(51) Int. Cl. G06F 17/30

(52) U.S. Cl. CPC G06F 17/30339; G06F 17/30315; G06F 17/30598

(57) ABSTRACT

A hybrid storage apparatus including a table generator for generating a table; a column group generator for generating a column group by collecting at least one column among one or more columns included in the table; and a segment allocation unit for allocating a base segment to the table and a group segment to the column group including the at least one column of the table. The base segment includes group segment link information regarding the group segment.

### RELATED APPLICATIONS

This application claims the benefit of Korean Patent Application No. 10-2014-0054932, filed on May 8, 2014, and Korean Patent Application No. 10-2014-0147620, filed on Oct. 28, 2014, in the Korean Intellectual Property Office, the disclosures of which are incorporated herein in their entireties by reference.

### BACKGROUND

1. Field

One or more exemplary embodiments relate to a database management system (DBMS), and more particularly, to a hybrid storage apparatus capable of storing data based on columns while maintaining a row-based data structure.

2. Description of the Related Art

In general, user queries sent to a database management system (DBMS) request access to data values of several columns of a row rather than access to data values of all columns of the row. However, existing N-array storage models (NSMs) store data in row units and are thus not suitable for processing such user queries.

To solve this problem, storage products for selectively using a storage model only for on-line analytical processing (OLAP) employing column-based storage and a storage model only for on-line transaction processing (OLTP) employing row-based storage have recently been introduced. In the storage products, both column-based storage and row-based storage should be implemented. Furthermore, in the case of the storage products, column-based storage or row-based storage should be selected within one table. Thus, the efficiency of the storage products is low when both a column-based query and a row-based query are input to one table.

### SUMMARY

One or more exemplary embodiments include a hybrid storage model manufactured by additionally including a column-based storage model into a general-purpose database management system (DBMS) so that a user may use the hybrid storage model both in a column-based on-line analytical processing (OLAP) environment and a row-based on-line transaction processing (OLTP) environment.

Additional aspects will be set forth in part in the description which follows and, in part, will be apparent from the description, or may be learned by practice of the presented embodiments.

According to one or more exemplary embodiments, a hybrid storage apparatus includes a table generator for generating a table; a column group generator for generating a column group by collecting at least one column among one or more columns included in the table; and a segment allocation unit for allocating a base segment to the table and a group segment to the column group which includes at least one column of the table, wherein the base segment includes group-segment link information regarding the group segment.

When a plurality of the column groups are present, the base segment may include group-segment link information regarding group segments that are respectively allocated to the plurality of column groups.

A group page into which a value of the at least one column belonging to the column group is to be inserted using the group segment may be allocated to the column group.

A base page may be allocated to the table by using the base segment, and information regarding records of the table may be stored in the base page.

According to one or more exemplary embodiments, a method of storing data in a hybrid storage apparatus based on columns while maintaining a row-based data structure includes generating a table by using a table generator; generating a column group by collecting at least one column among one or more columns forming the table by using a column group generator; and allocating a base segment to the table and a group segment to the column group which includes at least one column of the table by using a segment allocation unit, wherein the base segment includes group-segment link information regarding the group segment.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a hybrid storage apparatus according to an exemplary embodiment;

FIG. 2 is a diagram illustrating a table of a hybrid storage apparatus to which a base segment and a group segment are allocated, according to an exemplary embodiment;

FIG. 3 is a diagram illustrating a method of performing an ‘insert’ operation based on a segment structure as illustrated in FIG. 2, according to an exemplary embodiment;

FIGS. 4 and 5 illustrate index structures employed in a hybrid storage apparatus according to exemplary embodiments; and

FIGS. 6 and 7 are diagrams illustrating methods of compressing a column group and a record identifier (RID) in a hybrid storage apparatus according to exemplary embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description. As used herein, expressions such as “at least one of,” when preceding a list of elements, modify the entire list of elements and do not modify the individual elements of the list.

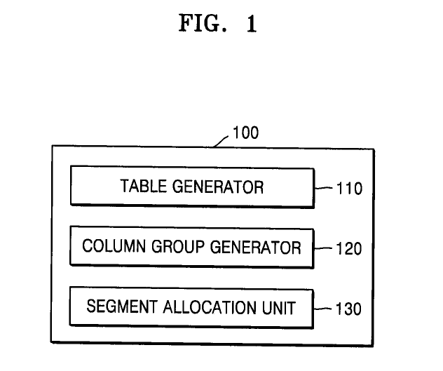

FIG. 1 is a block diagram of a hybrid storage apparatus 100 according to an exemplary embodiment.

The hybrid storage apparatus 100 includes a table generator 110, a column group generator 120, and a segment allocation unit 130.

The table generator 110 generates a table. In the table, data is stored based on columns and rows.

The column group generator 120 generates a column group by collecting at least one among one or more columns forming the table generated by the table generator 110. In this case, the column group generator 120 may support an interface via which a user may select at least one column among the one or more columns.

The segment allocation unit 130 allocates a base segment to the table generated by the table generator 110, and allocates a group segment to a column group related to the table. That is, the group segment is allocated to the column group which includes the columns of the table. In this case, the base segment includes group-segment link information regarding the allocated group segment.

According to an exemplary embodiment, the following table generation syntax may be input to the table generator 110 via a user interface.

[Table generation syntax]

Create Table T1((C1 integer, C2 char(5)) G1, C3 char(5),

C4 varchar(20) G2)

When the table is generated using the above syntax, the column group generator 120 generates a G1 column group with a C1 column and a C2 column, and a G2 column group with a C4 column. A column C3 is generated as a general column.

Data of columns belonging to a column group is stored in a group page, and data of columns that do not belong to the column group is stored in a base page.

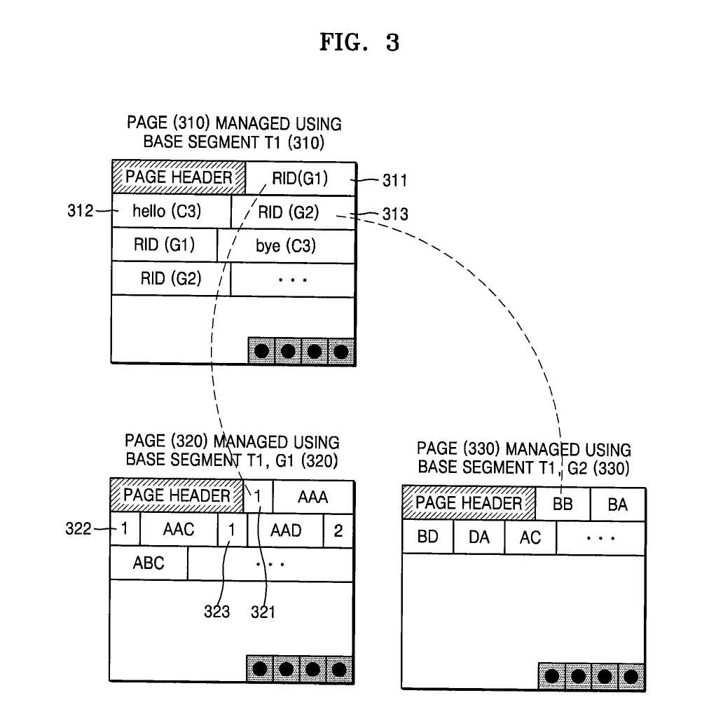

In detail, the G1 column group includes a plurality of columns. For example, the G1 column group may include the C1 column and the C2 column. Thus, a group page 320 of FIG. 3 generated to correspond to the G1 column group is stored in the form of (a value of the C1 column, a value of the C2 column); (a value of the C1 column, a value of the C2 column); (a value of the C1 column, a value of the C2 column), . . . . Referring to FIG. 3, the group page 320 is stored in the form of (1, AAA); (1, AAC); (1, AAD); (2, ABC), . . . . In this case, the values of only the columns belonging to the G1 column group are continuously listed and thus data may be considered as being stored based on columns.

In the case of the G2 column group, since only the C4 column constitutes the G2 column group, values of the C4 column are continuously listed and stored in a group page 330 of FIG. 3 generated to correspond to the G2 column group. Thus, data belonging to the group page 330 is stored based on columns.

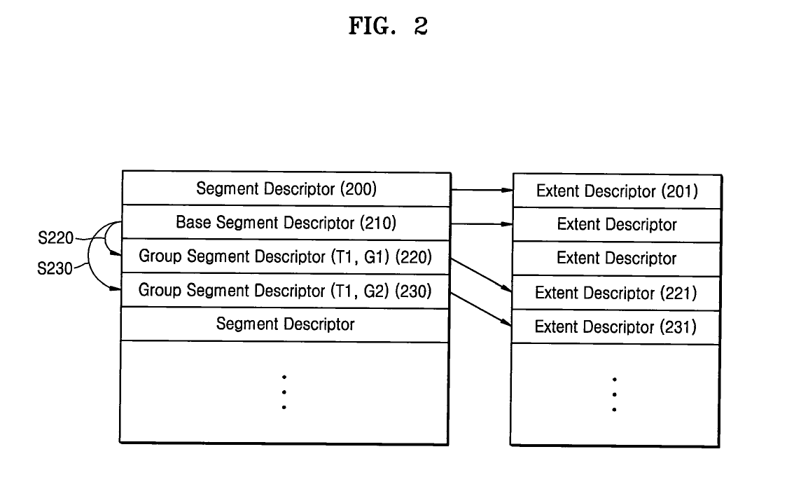

FIG. 2 is a diagram illustrating a table of the hybrid storage apparatus 100 of FIG. 1 to which a base segment and a group segment are allocated, according to an exemplary embodiment. FIG. 2.

The segment allocation unit 130 allocates a base segment and a group segment to a table generated by the table generator 110. Referring to FIG. 2, a base segment 210 is allocated to a table T1 generated using a table generation syntax. Group segments 220 and 230 are allocated to G1 and G2 column groups of the table T1, respectively. In this case, the base segment 210 includes group-segment link information S220 and S230 regarding the group segments 220 and 230 allocated to the G1 and G2 column groups. According to an exemplary embodiment, the hybrid storage apparatus 100 uses a hierarchical structure—a table space, a segment, an extent, and a page—used for row-based table management in a general database management system (DBMS).

Here, the segment should be understood as a table generated by a user. When data is to be inserted into, deleted from, or updated in a table, a segment descriptor 200 is detected, a page indicated in extent descriptors 201 pointed to by the segment descriptor 200 are detected, and data stored in the page is accessed.

According to an exemplary embodiment, pages indicated in extent descriptors pointed to by the base segment 210 and the group segments 220 and 230 are detected and data stored in the pages is accessed.

For example, referring to FIG. 3, a base page 310 indicated in an extent descriptor 201 pointed to by the base segment 210 is detected to access data stored therein.

Group pages 320 and 330 indicated in extent descriptors 221 and 231 pointed to by the G1 and G2 column groups are allocated to the G1 and G2 column groups, respectively.

Referring to FIG. 3, the base page 310 stores information of records of the table T1. A record identifier (RID) of a column group (e.g., the G1 and G2 column groups) is stored in a record of the base page 310. The column C3 that is a general column that does not belong to any column group (e.g., the G1 and G2 column groups) among one or more columns forming the table T1 (e.g., the C1, C2, C3, and C4 columns) has a column values such as ‘hello’ and ‘bye’ in FIG. 3.

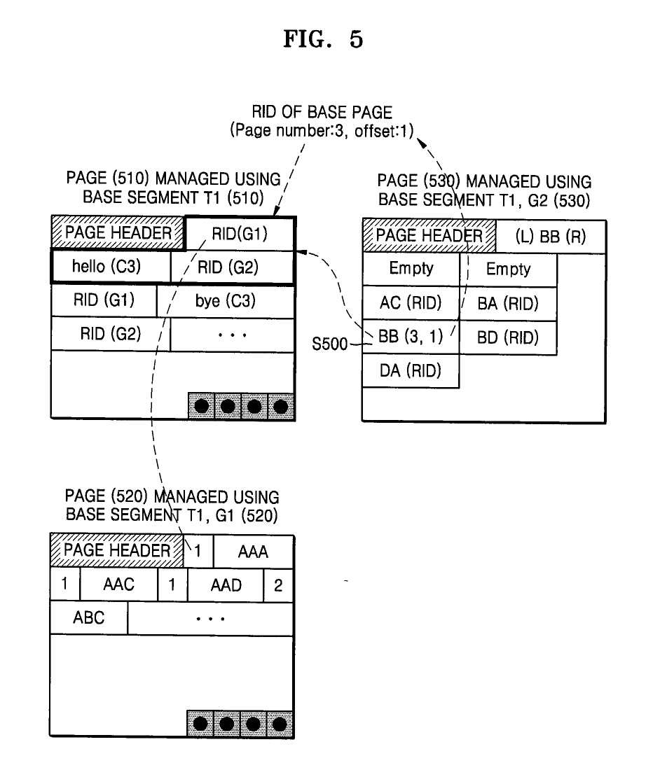

In this case, the information of the records of the table T1 further includes an RID identifying a page number of a group page in which the record of the column group is stored, and offset information of the record of the column group. Referring to FIG. 5, an RID of a base page T1 provides a page number and offset information.

A column value of at least one column (e.g., the C1, C2, and C4 columns) belonging to a column group (e.g., the G1 and G2 column groups) may be inserted into the group pages 320 and 330 by using the group segments 220 and 230.

Column values of the C1 column and the C2 column are inserted into the group page 320 pointed to by a group segment (T1, G1) 220. A column value of the C4 column is inserted into the group page 330 pointed to by a group segment (T1, G2) 230.

A process of performing an ‘insert’ operation, an ‘update’ operation, a ‘delete’ operation, and a ‘select’ operation based on a segment structure as illustrated in FIG. 2 will be described below. FIG. 3 is a diagram illustrating a method of performing the ‘insert’ operation based on a segment structure as illustrated in FIG. 2, according to an exemplary embodiment. The ‘insert’ operation will be described with reference to FIGS. 2 and 3 below.

Insert Operation

When a query “Insert into T1 Values(1, ‘AAA’, ‘hello’, ‘BB’)” is input, the ‘insert’ operation is performed as follows.

Pages into which columns are to be inserted are allocated using group segments 220 and 230. The G1 and G2 column groups are respectively allocated to the pages, a (1, ‘AAA’) record is recorded in the page to which the G1 column group is allocated, an RID representing the location of the (1, ‘AAA’) record is made and memorized, a (‘BB’) record is recorded in the page to which the G2 column group is allocated, and an RID representing the location of the (‘BB’) record is made and memorized. Then, a space into which a record may be inserted based on the base segment 210 of FIG. 2 is allocated. Thereafter, RIDs representing the locations of the 01 and G2 column groups are recorded using the RIDs made and memorized by recording the records of the G1 and G2 column groups in the group page in the case of the G1 and G2 column groups, and a column value is recorded in the case of a general column.

In detail, in the base page 310 of FIG. 3 pointed to by the base segment 210, an RID(G1) 311 of the G1 column group and an RID(G2) 313 of the G2 column group are stored, and ‘hello(C3)’ 312 which is a column value of the column C3 that is a general column is recorded.

The values of the C1 column and the C2 column of the G1 column group are recorded in the group page 320 pointed to by the group segment (T1, G1) 220 of FIG. 2 corresponding to the G1 column group. In this case, “1, AAA” is recorded as the values of the columns C1 and C2.

Similarly, “BB” is recorded in the group page 330 pointed by the group segment (T1, G2) 230 of FIG. 2 corresponding to the G2 column group.

According to another exemplary embodiment, a process of performing the ‘update’ operation by using a segment structure as illustrated in FIG. 2 will be described below.

(1) An Example of a Process of Performing the ‘Update’ Operation by Using a Single Column Group
Update T1 Set C2=BBB Where C1=1;

In this case, the C1 column and the C2 column form the G1 column group together and are thus stored in one group page. Thus, updating may be performed by accessing only the group segment(T1.G1) 220 of FIG. 2 without additionally accessing the base page 310 of FIG. 3 pointed to by the base segment 210 of FIG. 2.

Referring to FIG. 3, values 321, 322, and 323 which are all ‘1’ of the C1 column are detected in the group page 320 pointed to by the group segment(T1, G1) 220 of FIG. 2, and values ‘AAA’, ‘AAC’, and ‘AAD’ of the C2 column are updated as ‘BBB’.

(2) An Example of a Process of Performing the ‘Update’ Operation by Using a Plurality of Column Groups
Update T1 Set C2=BBB Where C4=BB;

In this case, a page in which the C4 column is stored is accessed using the RID(G2) 313 illustrated in FIG. 3 of the G2 column group to which the C4 column belongs while accessing the base segment 210 of FIG. 2 to individually read records. After such predicates are compared, when a record satisfying a condition is detected, the RID(G1) 311 of FIG. 3 of the record is used to locate and update the value of the C2 column as ‘BBB’.

According to another exemplary embodiment, a process of performing the ‘delete’ operation by using a segment structure as illustrated in FIG. 2 will be described below. Through the ‘delete’ operation, the base page 310 of FIG. 3 pointed to by the base segment 210 of FIG. 2 is accessed, all RIDs stored in a record of the base page 310 are detected, and a deletion mark is assigned to not only all the group column records of group pages using the RIDs but also the record.

According to another exemplary embodiment, a process of performing the ‘select’ operation by using a segment structure as illustrated in FIG. 2 will now be described.

(1) An Example of a Process of Performing the ‘Select’ Operation by Using a Single Column Group
Select AVG(C1) from T1 where C2 like ‘AA %’

In this case, a C1 column and a C2 column of a record satisfying a condition may be accessed directly by accessing only the group segment (T1, G1) 220 of FIG. 2 without additionally accessing the base page 310 of FIG. 3 pointed to by the base segment 210 of FIG. 2.

(2) An Example of a Process of Performing the ‘Select’ Operation by Using a Plurality of Column Groups
Select*from T1;

As described above, a query requesting to access all records that are mainly used in an OLTP environment is returned by forming a row by accessing the base page 310 of FIG. 3 pointed to by the base segment 210 of FIG. 2.

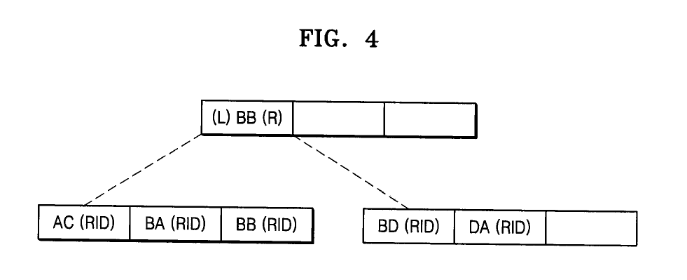

FIGS. 4 and 5 illustrate index structures employed in a hybrid storage apparatus according to exemplary embodiments.

According to an exemplary embodiment, a hybrid storage apparatus may be embodied such that only a most significant RID of the base page 310 of FIG. 3 is stored in an index. In other words, in the index used in the hybrid storage apparatus, only an RID of a record of the base page 310 of FIG. 3 storing the RIDs of the records of the G1 and G2 column groups and a data value of a general column may be used without storing the RIDs of the G1 and G2 column groups which represent the locations of the values of the column C1 and the column C2 belonging to the G1 column group and the C4 column belonging to the G2 column group.

If it is assumed that the G2 column group of the table T1 is indexed, a B-tree index may be configured as illustrated in FIG. 4. In this case, an RID of each leaf stores an RID of a base page.

Referring to FIG. 5, a page 530 pointed to by a group segment (T1, G2) consists of pages storing an index. The page 530 pointed to by the group segment (T1, G2) includes values of leaf nodes and an RID of a base page for a record of the page 530.

For example, in the page 530 pointed to by the group segment (T1, G2), an index “BB (3,1)” indicates a first record of a third page of a base segment.

In this case, since all records of a table may be retrieved using a specific column, the index structure shows high performance for even the following OLTP query.
Select*from T1 where C4=‘BB’

FIG. 6 is a diagram illustrating a process of compressing a G2 column group according to an exemplary embodiment.

Since storing is performed in a group page in units of column groups, data may be compressed using dictionary or difference-based compression.

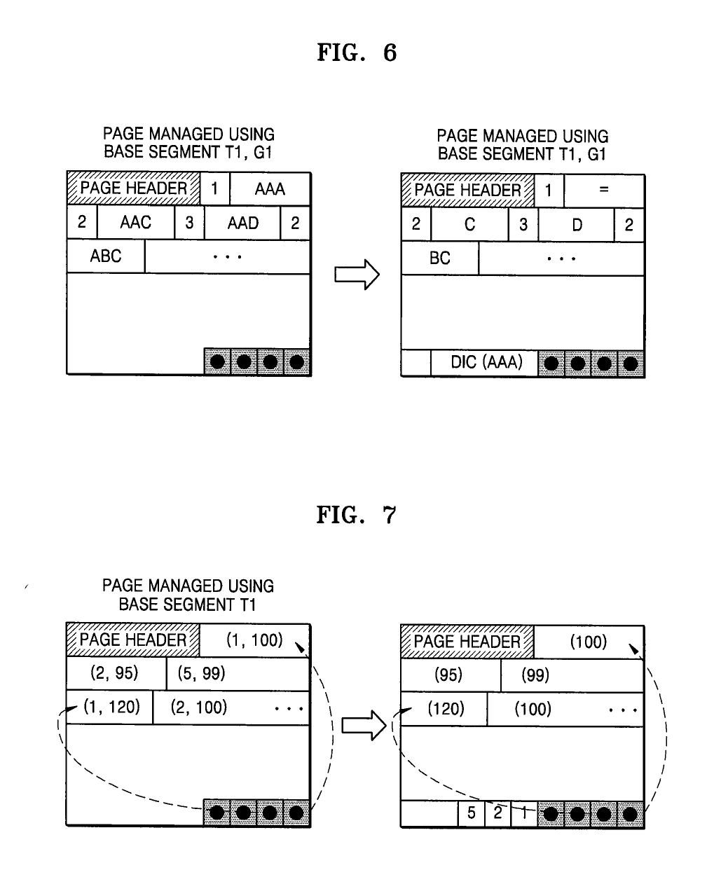

FIG. 7 is a diagram illustrating a process of compressing an RID of a record according to an exemplary embodiment.

An RID of a group column record is stored in a base page. In this case, the RID of the group column record is stored in the form of <page number, offset>. However, the same page number is likely to be repeatedly used in RIDs of records since some group column records are stored in a group page. In this case, data may be compressed using dictionary or difference-based compression.

An offset may be processed similarly. For example, a base offset may be set as a reference value and the difference between the base offset and a target value may be stored, thereby reducing a storage space.

As described above, according to the one or more of the above exemplary embodiments, data may be stored in a hybrid storage apparatus based on columns while maintaining a row-based data structure.

Also, the architecture of an existing DBMS employing an N-array storage model (NSM) may be used. Also, the advantages of a column-based DBMS may be achieved. According to an exemplary embodiment, a hybrid storage apparatus has a structure in which columns are gathered and the advantages of a partition attribute across (PAX) model may be also achieved. That is, a cache miss may decrease.

According to an exemplary embodiment, a column-based approach may be performed on hybrid storage without a join operation which is needed in a column-based storage. Also, since a function of selecting a user's desired column group is provided, a storage structure may be controlled by the user. Thus, a storage structure optimum for a user's desired OLTP and OLAP may be provided.

Also, according to an exemplary embodiment, in a hybrid storage apparatus, an RID is used to easily access data in units of records.

A hybrid storage apparatus and a method of storing data in the hybrid storage apparatus based on columns while maintaining a row-based data structure may be embodied as program instructions that can be executed by various computing means and recorded on a computer-readable recording medium. The computer-readable recording medium may store program instructions, data files, data structures, etc. solely or in combination. The program instructions recorded on the computer-readable recording medium may be specially designed and configured for the inventive concept or may be well-known to those of ordinary skill in the field of computer software.

Examples of the computer-readable recording medium include a magnetic medium (such as a hard disc, a floppy disk, and a magnetic tape), an optical medium (such as a compact disc (CD)-read-only memory (ROM) and a digital versatile memory (DVD)), a magneto-optical medium (such as a floptical disk), and a hardware device specially configured to store and execute program instructions (such as a ROM, a random access memory (RAM), and a flash memory).

The program instructions include not only machine language codes prepared by a compiler but also high-level codes executable by a computer by using an interpreter. The hardware device may be configured to operate as at least one module to perform operations according to the inventive concept, or vice versa.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A hybrid storage apparatus comprising:
a table generator for generating a table;
a column group generator for generating a column group by collecting at least one column among one or more columns included in the table; and
a segment allocation unit for allocating a base segment to the table and a group segment to the column group which includes at least one column of the table,
wherein the base segment comprises group-segment link information regarding the group segment.

2. The hybrid storage apparatus of claim 1, wherein, when a plurality of the column groups are present, the base segment comprises group-segment link information regarding group segments that are respectively allocated to the plurality of column groups.

3. The hybrid storage apparatus of claim 1, wherein a group page into which a value of the at least one column belonging to the column group is to be inserted using the group segment is allocated to the column group.

4. The hybrid storage apparatus of claim 3, wherein dictionary or difference-based data compression is performed in the group page.

5. The hybrid storage apparatus of claim 1, wherein a base page is allocated to the table by using the base segment, and
information regarding records of the table is stored in the base page.

6. The hybrid storage apparatus of claim 5, wherein the information regarding the records of the table further comprises:
a record identifier (RID) identifying a page number of a group page in which a record of the column group is stored, and offset information of the record of the column group.

7. The hybrid storage apparatus of claim 5, wherein the information regarding the records of the table comprises a value of a general column that does not belong to the column group among the one or more columns included in the table.

8. The hybrid storage apparatus of claim 1, wherein the column group generator is configured to support an interface via which at least one column among the one or more columns is to be selected by a user.

9. The hybrid storage apparatus of claim 1, wherein, when data is to be inserted into, deleted from, or updated in the table, data stored in a page present in an extent pointed to by the base segment is accessed using the base segment, and data stored in a page present in an extent pointed to by the group segment is accessed using the group segment.
wherein the base segment or the group segment is aware of extent information, wherein the extent information includes information regarding a space in which data of the base segment or the group segment is to be inserted.

10. The hybrid storage apparatus of claim 1, wherein data is stored in the table based on columns.

11. The hybrid storage apparatus of claim 1, wherein, when an index of the at least one column belonging to the column group is configured, an RID of a record of a table including the column group is used.

12. A method of storing data in a hybrid storage apparatus based on columns while maintaining a row-based data structure, the method comprising:
generating a table by using a table generator;
generating a column group by collecting at least one column among one or more columns forming the table by using a column group generator; and
allocating a base segment to the table and a group segment to the column group which includes at least one column of the table by using a segment allocation unit,
wherein the base segment comprises group-segment link information regarding the group segment.

13. The method of claim 12, wherein, when a plurality of the column groups are present, the base segment comprises group-segment link information regarding group segments that are respectively allocated to the plurality of column groups.

14. The method of claim 12, wherein a base page is allocated to the table by using the base segment, and
a group page into which a value of the at least one column belonging to the column group is to be inserted by using the group segment is allocated to the column group.
